(19) United States
(12) Patent Application Publication
(10) Pub. No.: US 2022/0272136 A1
(43) Pub. Date: Aug. 25, 2022

(54) CONTEXT BASED CONTENT POSITIONING IN CONTENT DELIVERY NETWORKS

(71) Applicant: International Business Machines Corporation, Armonk, NY (US)

(72) Inventors: Craig M. Trim, Ventura, CA (US); Mary Rudden, Denver, CO (US); Anthony Stevens, San Francisco, CA (US); Martin G. Keen, Cary, NC (US)

(73) Assignee: International Business Machines Corporatlion, Armonk, NY (US)

(21) Appl. No.: 17/179,661

(22) Filed: Feb. 19, 2021

(51) Int. Cl. H04L 29/06; H04L 29/08

(52) U.S. Cl. CPC H04L 65/4084; H04L 65/4076; H04L 67/1076; H04L 67/2895

(57) ABSTRACT

A set of nodes of a content delivery network are weighted according to an effect of a node on a network. A data points parameter specifying a number of nodes constituting a cluster is set according to a policy. A subset of the weighted nodes is clustered according to the data points parameter. A cluster comprises nodes having a content access history similarity greater than a threshold similarity. A structured representation of a natural language document is positioned at a node within the cluster, the positioning determined by evaluating a similarity between the structured representation and a content access history of the node.

### BACKGROUND

The present invention relates generally to a method, system, and computer program product for managing content in content delivery networks. More particularly, the present invention relates to a method, system, and computer program product for context based content positioning in content delivery networks.

A content delivery network or content distribution network (CDN) is a geographically distributed network of proxy servers and their data centers. CDNs serve content over networks such as the Internet, including web objects (e.g. text, graphics, and scripts), downloadable objects (e.g. media files, software, and documents), applications (e.g. e-commerce and portals), live streaming media, on-demand streaming media, online gaming, and social networks. Because storing content at a central data center creates very large data loads at one network location and increased latency within the network, CDNs typically combine core data centers with edge data centers. The edge data centers cache the most popular content closer to end users for traffic load and latency reduction.

CDNs serve content to any device capable of communicating with the CDN. Because 5G mobile networking is faster than previous generations of mobile data communications, as 5G becomes available demand for content delivery over 5G is expected to increase. However, 5G networking typically uses a set of access points intended to serve a smaller geographic area than 4G access points, thus increasing the number of points at which content can be cached. 5G access points, because they serve a smaller area, often have less storage capacity than previous access points, thus requiring more precision in determining which content is cached where.

### SUMMARY

The illustrative embodiments provide a method, system, and computer program product. An embodiment includes a method that weights, according to an effect of a node on a network, a set of nodes of a content delivery network. An embodiment sets, according to a policy, a data points parameter, the data points parameter specifying a number of nodes constituting a cluster. An embodiment clusters, according to the data points parameter, a subset of the weighted nodes, a cluster comprising nodes having a content access history similarity greater than a threshold similarity. An embodiment positions, at a node within the cluster, a structured representation of a natural language document, the positioning determined by evaluating a similarity between the structured representation and a content access history of the node.

An embodiment includes a computer usable program product. The computer usable program product includes one or more computer-readable storage devices, and program instructions stored on at least one of the one or more storage devices.

An embodiment includes a computer system. The computer system includes one or more processors, one or more computer-readable memories, and one or more computer-readable storage devices, and program instructions stored on at least one of the one or more storage devices for execution by at least one of the one or more processors via at least one of the one or more memories.

### BRIEF DESCRIPTION OF THE DRAWINGS

Certain novel features believed characteristic of the invention are set forth in the appended claims. The invention itself, however, as well as a preferred mode of use, further objectives and advantages thereof, will best be understood by reference to the following detailed description of the illustrative embodiments when read in conjunction with the accompanying drawings, wherein:

FIG. 1 depicts a block diagram of a network of data processing systems in which illustrative embodiments may be implemented;

FIG. 2 depicts a block diagram of a data processing system in which illustrative embodiments may be implemented;

FIG. 3 depicts a block diagram of an example configuration for context based content positioning in content delivery networks in accordance with an illustrative embodiment;

FIG. 4 depicts an example of context based content positioning in content delivery networks in accordance with an illustrative embodiment;

FIG. 5 depicts a flowchart of an example process for context based content positioning in content delivery networks in accordance with an illustrative embodiment;

FIG. 6 depicts a cloud computing environment according to an embodiment of the present invention; and

FIG. 7 depicts abstraction model layers according to an embodiment of the present invention.

### DETAILED DESCRIPTION

The illustrative embodiments recognize that, as the number of access points in a CDN increases and the amount of content provided via the CDN grows, optimizing content positioning at access points becomes more important in providing content delivery with the responsiveness users require. However, the CDN itself also becomes more complex, including many more access points and routers directing traffic among access points. As a result, optimizing content positioning involves determining the best path from data center to user from among a complex set of possible paths.

The illustrative embodiments also recognize that one current technique for optimizing content positioning includes modeling content delivery paths within a CDN as a graph space, and partitioning the graph space into clusters in which each cluster represents a set of users with similar content needs. However, presently available clustering techniques such as k-means, hierarchical, and fuzzy clustering group data in an unsupervised way, without reference to users' actual content requests. When unsupervised clustering techniques are applied to content positioning, elements in the same cluster might not share enough similarities. As a result, content positioning using unsupervised clustering techniques results in negligible performance gains or even makes content delivery performance worse. Consequently, the illustrative embodiments recognize that there is an unmet need for an improved CDN clustering techniques for use in positioning content on a CDN for improved content delivery performance.

The illustrative embodiments recognize that the presently available tools or solutions do not address these needs or provide adequate solutions for these needs. The illustrative embodiments used to describe the invention generally address and solve the above-described problems and other problems related to context based content positioning in content delivery networks.

An embodiment can be implemented as a software application. The application implementing an embodiment can be configured as a modification of an existing content delivery system, as a separate application that operates in conjunction with an existing content delivery system, a standalone application, or some combination thereof.

Particularly, some illustrative embodiments provide a method that weights a set of nodes of a content delivery network according to an effect of a node on the network, sets a data points parameter according to a policy, clusters a subset of the weighted nodes according to the data points parameter, and positions a structured representation of a natural language document at a node within the cluster.

An embodiment receives a structured description of an unstructured, natural language content. One embodiment receives unstructured content in the form of a natural language document. Another embodiment receives unstructured content in the form of audio, video, a still-image presentation, or another non-textual form or combination of textual and non-textual content, and converts the non-textual content to natural language textual form using a presently-available technique.

An embodiment weights a set of nodes of a content delivery network according to an effect of a node on the network. Data positioning at some network nodes has more of an effect on CDN performance than data positioning at other nodes. For example, a 5G access point, which includes a data caching capability, might provide network access to a relatively small number of devices within transmission range. On the other hand, an edge data center might service and cache data for a number of access points, and a core data center might service and cache data for a number of edge data centers. Thus, there is a tradeoff between locating data closer to a network edge, providing relatively rapid response time to a smaller number of potential users, and locating data closer to a network center, providing relatively slower response time but to a larger group of potential users. Thus, one embodiment weights a set of nodes of a content delivery network according to a node's throughput, with a higher-throughput node (e.g. an edge data center) weighed higher than a lower-throughput node (e.g. a 5G access point). Another embodiment weights a set of nodes of a content delivery network according to a node's data request capacity, with a node having a higher capacity to serve simultaneous data requests (e.g. an edge data center) weighed higher than a node having a lower capacity to serve simultaneous data requests (e.g. a 5G access point). Another embodiment weights a set of nodes of a content delivery network according to another scheme for measuring an effect of a node on the network.

An embodiment sets a value of a data points parameter. The data points parameter is an input parameter to a clustering algorithm and specifies a number of data points constituting a cluster. One embodiment sets a value of a data points parameter according to a policy. One non-limiting example of a data points parameter policy sets the parameter according to the network size. Another non-limiting example of a data points parameter policy sets the parameter according to the data storage capacity in a portion of the network. Another non-limiting example of a data points parameter policy sets the parameter according to the cache capacity in a portion of the network. Other policies are also possible and contemplated within the scope of the illustrative embodiments.

An embodiment uses a clustering algorithm to form the weighted nodes into clusters. A criterion for forming a cluster is that a node in the cluster have a content access history with greater than a threshold similarity to the content access history of another node in the cluster. Techniques for measuring content access history similarity are presently available. Nodes near where a type of content was previously accessed are nodes where that type of content is more likely to be accessed again. Thus, nodes in a cluster represent options for data placement. Content access history is also referred to as context. The algorithm determines how many nodes form a cluster using the data points parameter. One embodiment uses, as a clustering algorithm, density-based spatial clustering of applications with noise (DBSCAN). Given a set of points in some space, DBSCAN groups together points that are closely packed together (points with many nearby neighbors), marking as outliers points that lie alone in low-density regions (whose nearest neighbors are too far away). DBSCAN and variants of DBSCAN, as well as other clustering algorithms, are presently available.

An embodiment positions, within data storage at a node within a cluster, a structured representation of a natural language document. In one embodiment, the node at which the data is positioned is selected by evaluating a similarity between the content access history and the structured representation. In another embodiment, the structured representation is not positioned until there have been above a threshold number of accesses to sufficiently similar content. In another embodiment, the structured representation is not positioned until there have been above a threshold number of accesses within a predetermined time period to sufficiently similar content. Waiting until a threshold number of accesses, or a threshold number of accesses within a time period, has occurred prevents data movement before a genuine pattern has been established.

An embodiment uses a reinforcement learning method to adjust node weights and the data points parameter. One embodiment monitors a usage rate of data placed at one or more nodes. A data usage rate below a threshold data usage rate suggests that the data should have been placed further from the network edge. Therefore, if the data usage rate is below a threshold data usage rate, an embodiment increases the value of the data points parameter. The increased value causes the clustering algorithm to generate larger clusters. Another embodiment compares the actual data usage rate at a node to an expected data usage rate, for that specific node or that type of node. The embodiment determines the expected data usage rate from a past pattern of data usage, a past pattern of a particular type of data usage, a past pattern of data user type, using another method, or using a combination of methods. If the actual data usage rate at a node is above a threshold difference from the expected data usage rate, an embodiment adjusts the set of node weights. One embodiment adjusts the set of node weights by increasing the weight of the node at which data usage was higher than expected. Another embodiment adjusts the set of node weights by increasing the weight of the node at which data usage was higher than expected and lowering weights of other nodes, such as nodes near the node having an increased weight or nodes closer to the network center than the node having an increased weight.

The manner of context based content positioning in content delivery networks described herein is unavailable in the presently available methods in the technological field of endeavor pertaining to content delivery networks. A method of an embodiment described herein, when implemented to execute on a device or data processing system, comprises substantial advancement of the functionality of that device or data processing system in weighting a set of nodes of a content delivery network according to an effect of a node on the network, setting a data points parameter according to a policy, clustering a subset of the weighted nodes according to the data points parameter, and positioning a structured representation of a natural language document at a node within the cluster.

The illustrative embodiments are described with respect to certain types of natural language documents, structured representations, nodes, parameters, weights, similarities, thresholds, adjustments, devices, data processing systems, environments, components, and applications only as examples. Any specific manifestations of these and other similar artifacts are not intended to be limiting to the invention. Any suitable manifestation of these and other similar artifacts can be selected within the scope of the illustrative embodiments.

Furthermore, the illustrative embodiments may be implemented with respect to any type of data, data source, or access to a data source over a data network. Any type of data storage device may provide the data to an embodiment of the invention, either locally at a data processing system or over a data network, within the scope of the invention. Where an embodiment is described using a mobile device, any type of data storage device suitable for use with the mobile device may provide the data to such embodiment, either locally at the mobile device or over a data network, within the scope of the illustrative embodiments.

The illustrative embodiments are described using specific code, designs, architectures, protocols, layouts, schematics, and tools only as examples and are not limiting to the illustrative embodiments. Furthermore, the illustrative embodiments are described in some instances using particular software, tools, and data processing environments only as an example for the clarity of the description. The illustrative embodiments may be used in conjunction with other comparable or similarly purposed structures, systems, applications, or architectures. For example, other comparable mobile devices, structures, systems, applications, or architectures therefor, may be used in conjunction with such embodiment of the invention within the scope of the invention. An illustrative embodiment may be implemented in hardware, software, or a combination thereof.

The examples in this disclosure are used only for the clarity of the description and are not limiting to the illustrative embodiments. Additional data, operations, actions, tasks, activities, and manipulations will be conceivable from this disclosure and the same are contemplated within the scope of the illustrative embodiments.

Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

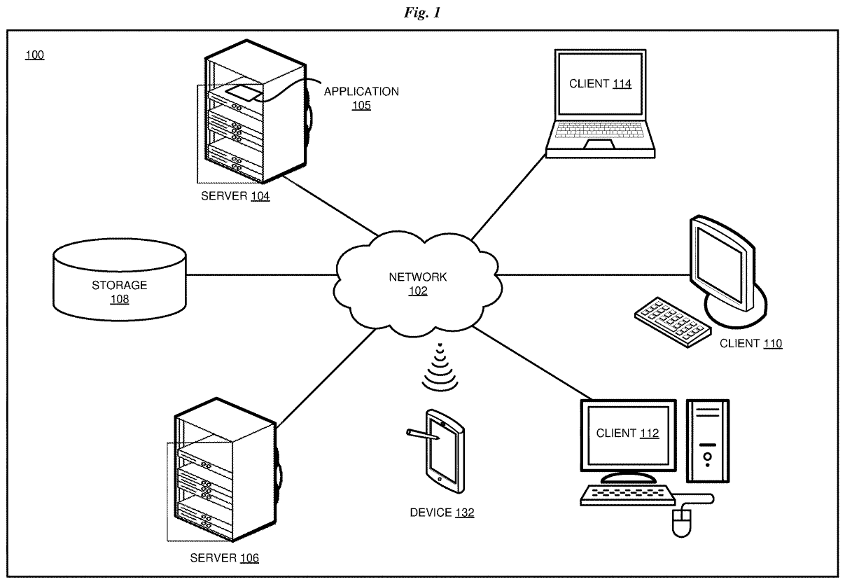

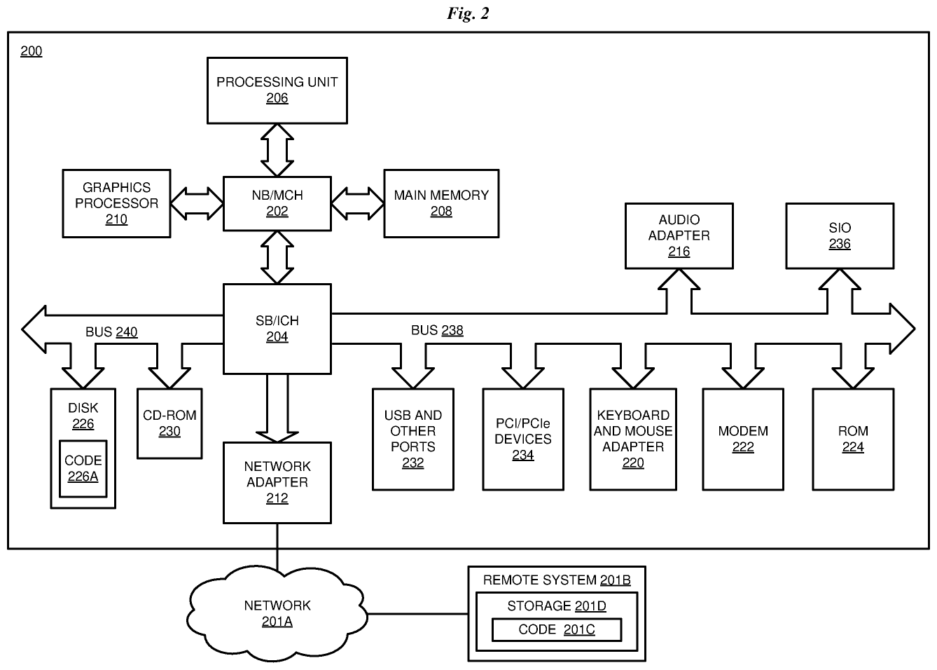

With reference to the figures and in particular with reference to FIGS. 1 and 2, these figures are example diagrams of data processing environments in which illustrative embodiments may be implemented. FIGS. 1 and 2 are only examples and are not intended to assert or imply any limitation with regard to the environments in which different embodiments may be implemented. A particular implementation may make many modifications to the depicted environments based on the following description.

FIG. 1 depicts a block diagram of a network of data processing systems in which illustrative embodiments may be implemented. Data processing environment 100 is a network of computers in which the illustrative embodiments may be implemented. Data processing environment 100 includes network 102. Network 102 is the medium used to provide communications links between various devices and computers connected together within data processing environment 100. Network 102 may include connections, such as wire, wireless communication links, or fiber optic cables.

Clients or servers are only example roles of certain data processing systems connected to network 102 and are not intended to exclude other configurations or roles for these data processing systems. Server 104 and server 106 couple to network 102 along with storage unit 108. Software applications may execute on any computer in data processing environment 100. Clients 110, 112, and 114 are also coupled to network 102. A data processing system, such as server 104 or 106, or client 110, 112, or 114 may contain data and may have software applications or software tools executing thereon.

Only as an example, and without implying any limitation to such architecture, FIG. 1 depicts certain components that are usable in an example implementation of an embodiment. For example, servers 104 and 106, and clients 110, 112, 114, are depicted as servers and clients only as example and not to imply a limitation to a client-server architecture. As another example, an embodiment can be distributed across several data processing systems and a data network as shown, whereas another embodiment can be implemented on a single data processing system within the scope of the illustrative embodiments. Data processing systems 104, 106, 110, 112, and 114 also represent example nodes in a cluster, partitions, and other configurations suitable for implementing an embodiment.

Device 132 is an example of a device described herein. For example, device 132 can take the form of a smartphone, a tablet computer, a laptop computer, client 110 in a stationary or a portable form, a wearable computing device, or any other suitable device. Any software application described as executing in another data processing system in FIG. 1 can be configured to execute in device 132 in a similar manner. Any data or information stored or produced in another data processing system in FIG. 1 can be configured to be stored or produced in device 132 in a similar manner.

Application 105 implements an embodiment described herein. Application 105 executes in any of servers 104 and 106, clients 110, 112, and 114, and device 132. Application 105 manages content on a content delivery network. Nodes within the content delivery network can be implemented within any of servers 104 and 106, clients 110, 112, and 114, device 132, or another device on network 102.

Servers 104 and 106, storage unit 108, and clients 110, 112, and 114, and device 132 may couple to network 102 using wired connections, wireless communication protocols, or other suitable data connectivity. Clients 110, 112, and 114 may be, for example, personal computers or network computers.

In the depicted example, server 104 may provide data, such as boot files, operating system images, and applications to clients 110, 112, and 114. Clients 110, 112, and 114 may be clients to server 104 in this example. Clients 110, 112, 114, or some combination thereof, may include their own data, boot files, operating system images, and applications. Data processing environment 100 may include additional servers, clients, and other devices that are not shown.

In the depicted example, data processing environment 100 may be the Internet. Network 102 may represent a collection of networks and gateways that use the Transmission Control Protocol/Internet Protocol (TCP/IP) and other protocols to communicate with one another. At the heart of the Internet is a backbone of data communication links between major nodes or host computers, including thousands of commercial, governmental, educational, and other computer systems that route data and messages. Of course, data processing environment 100 also may be implemented as a number of different types of networks, such as for example, an intranet, a local area network (LAN), or a wide area network (WAN). FIG. 1 is intended as an example, and not as an architectural limitation for the different illustrative embodiments.

Among other uses, data processing environment 100 may be used for implementing a client-server environment in which the illustrative embodiments may be implemented. A client-server environment enables software applications and data to be distributed across a network such that an application functions by using the interactivity between a client data processing system and a server data processing system. Data processing environment 100 may also employ a service oriented architecture where interoperable software components distributed across a network may be packaged together as coherent business applications. Data processing environment 100 may also take the form of a cloud, and employ a cloud computing model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service.

With reference to FIG. 2, this figure depicts a block diagram of a data processing system in which illustrative embodiments may be implemented. Data processing system 200 is an example of a computer, such as servers 104 and 106, or clients 110, 112, and 114 in FIG. 1, or another type of device in which computer usable program code or instructions implementing the processes may be located for the illustrative embodiments.

Data processing system 200 is also representative of a data processing system or a configuration therein, such as data processing system 132 in FIG. 1 in which computer usable program code or instructions implementing the processes of the illustrative embodiments may be located. Data processing system 200 is described as a computer only as an example, without being limited thereto. Implementations in the form of other devices, such as device 132 in FIG. 1, may modify data processing system 200, such as by adding a touch interface, and even eliminate certain depicted components from data processing system 200 without departing from the general description of the operations and functions of data processing system 200 described herein.

In the depicted example, data processing system 200 employs a hub architecture including North Bridge and memory controller hub (NB/MCH) 202 and South Bridge and input/output (I/O) controller hub (SB/ICH) 204. Processing unit 206, main memory 208, and graphics processor 210 are coupled to North Bridge and memory controller hub (NB/MCH) 202. Processing unit 206 may contain one or more processors and may be implemented using one or more heterogeneous processor systems. Processing unit 206 may be a multi-core processor. Graphics processor 210 may be coupled to NB/MCH 202 through an accelerated graphics port (AGP) in certain implementations.

In the depicted example, local area network (LAN) adapter 212 is coupled to South Bridge and I/O controller hub (SB/ICH) 204. Audio adapter 216, keyboard and mouse adapter 220, modem 222, read only memory (ROM) 224, universal serial bus (USB) and other ports 232, and PCI/PCIe devices 234 are coupled to South Bridge and I/O controller hub 204 through bus 238. Hard disk drive (HDD) or solid-state drive (SSD) 226 and CD-ROM 230 are coupled to South Bridge and I/O controller hub 204 through bus 240. PCI/PCIe devices 234 may include, for example, Ethernet adapters, add-in cards, and PC cards for notebook computers. PCI uses a card bus controller, while PCIe does not. ROM 224 may be, for example, a flash binary input/output system (BIOS). Hard disk drive 226 and CD-ROM 230 may use, for example, an integrated drive electronics (IDE), serial advanced technology attachment (SATA) interface, or variants such as external-SATA (eSATA) and micro-SATA (mSATA). A super I/O (SIO) device 236 may be coupled to South Bridge and I/O controller hub (SB/ICH) 204 through bus 238.

Memories, such as main memory 208, ROM 224, or flash memory (not shown), are some examples of computer usable storage devices. Hard disk drive or solid state drive 226, CD-ROM 230, and other similarly usable devices are some examples of computer usable storage devices including a computer usable storage medium.

An operating system runs on processing unit 206. The operating system coordinates and provides control of various components within data processing system 200 in FIG. 2. The operating system may be a commercially available operating system for any type of computing platform, including but not limited to server systems, personal computers, and mobile devices. An object oriented or other type of programming system may operate in conjunction with the operating system and provide calls to the operating system from programs or applications executing on data processing system 200.

Instructions for the operating system, the object-oriented programming system, and applications or programs, such as application 105 in FIG. 1, are located on storage devices, such as in the form of code 226A on hard disk drive 226, and may be loaded into at least one of one or more memories, such as main memory 208, for execution by processing unit 206. The processes of the illustrative embodiments may be performed by processing unit 206 using computer implemented instructions, which may be located in a memory, such as, for example, main memory 208, read only memory 224, or in one or more peripheral devices.

Furthermore, in one case, code 226A may be downloaded over network 201A from remote system 201B, where similar code 201C is stored on a storage device 201D. in another case, code 226A may be downloaded over network 201A to remote system 201B, where downloaded code 201C is stored on a storage device 201D.

The hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. In addition, the processes of the illustrative embodiments may be applied to a multiprocessor data processing system.

In some illustrative examples, data processing system 200 may be a personal digital assistant (PDA), which is generally configured with flash memory to provide non-volatile memory for storing operating system files and/or user-generated data. A bus system may comprise one or more buses, such as a system bus, an I/O bus, and a PCI bus. Of course, the bus system may be implemented using any type of communications fabric or architecture that provides for a transfer of data between different components or devices attached to the fabric or architecture.

A communications unit may include one or more devices used to transmit and receive data, such as a modem or a network adapter. A memory may be, for example, main memory 208 or a cache, such as the cache found in North Bridge and memory controller hub 202. A processing unit may include one or more processors or CPUs.

The depicted examples in FIGS. 1-2 and above-described examples are not meant to imply architectural limitations. For example, data processing system 200 also may be a tablet computer, laptop computer, or telephone device in addition to taking the form of a mobile or wearable device.

Where a computer or data processing system is described as a virtual machine, a virtual device, or a virtual component, the virtual machine, virtual device, or the virtual component operates in the manner of data processing system 200 using virtualized manifestation of some or all components depicted in data processing system 200. For example, in a virtual machine, virtual device, or virtual component, processing unit 206 is manifested as a virtualized instance of all or some number of hardware processing units 206 available in a host data processing system, main memory 208 is manifested as a virtualized instance of all or some portion of main memory 208 that may be available in the host data processing system, and disk 226 is manifested as a virtualized instance of all or some portion of disk 226 that may be available in the host data processing system. The host data processing system in such cases is represented by data processing system 200.

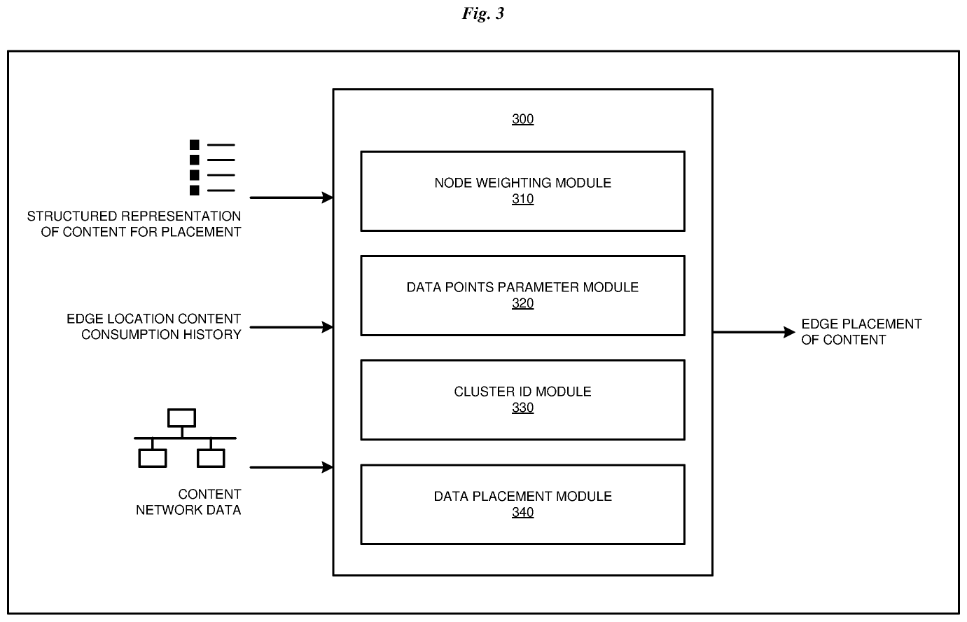

With reference to FIG. 3, this figure depicts a block diagram of an example configuration for context based content positioning in content delivery networks in accordance with an illustrative embodiment. Application 300 is an example of application 105 in FIG. 1 and executes in any of servers 104 and 106, clients 110, 112, and 114, and device 132 in FIG. 1.

Node weighting module 310 weights a set of nodes of a content delivery network according to an effect of a node on the network. One implementation of module 310 weights a set of nodes of a CDN according to a node's throughput, with a higher-throughput node (e.g. an edge data center) weighed higher than a lower-throughput node (e.g. a 5G access point). Another implementation of module 310 weights a set of nodes of a CDN according to a node's data request capacity, with a node having a higher capacity to serve simultaneous data requests (e.g. an edge data center) weighed higher than a node having a lower capacity to serve simultaneous data requests (e.g. a 5G access point). Another implementation of module 310 weights a set of nodes of a CDN according to another scheme for measuring an effect of a node on the network.

Data points parameter module 320 sets a value of a data points parameter. The data points parameter is an input parameter to a clustering algorithm and specifies a number of data points constituting a cluster. One implementation of module 320 sets a value of a data points parameter according to a policy. One non-limiting example of data points parameter policy sets the parameter according to the network size. Another non-limiting example of a data points parameter policy sets the parameter according to the data storage capacity in a portion of the network.

Cluster identification module 330 uses a clustering algorithm to form the weighted nodes into clusters. Nodes in a cluster represent options for data placement. The algorithm determines how many nodes form a cluster using the data points parameter. One implementation uses, as a clustering algorithm, the DBSCAN algorithm.

Data placement module 340 positions, within data storage at a node within a cluster, a structured representation of a natural language document. In one implementation of module 340, the node at which the data is positioned is selected by evaluating a similarity between the content access history and the structured representation. In another implementation of module 340, the structured representation is not positioned until there have been above a threshold number of accesses to sufficiently similar content. In another implementation of module 340, the structured representation is not positioned until there have been above a threshold number of accesses within a predetermined time period to sufficiently similar content.

Application 300 uses a reinforcement learning method to adjust node weights and the data points parameter. One implementation of application 300 monitors a usage rate of data placed at one or more nodes. If the data usage rate is below a threshold data usage rate, data points parameter module 320 increases the value of the data points parameter. Another implementation of application 300 compares the actual data usage rate at a node to an expected data usage rate, for that specific node or that type of node. The implementation determines the expected data usage rate from a past pattern of data usage, a past pattern of a particular type of data usage, a past pattern of data user type, using another method, or using a combination of methods. If the actual data usage rate at a node is above a threshold difference from the expected data usage rate, node weighting module 310 adjusts the set of node weights. One implementation of module 310 adjusts the set of node weights by increasing the weight of the node at which data usage was higher than expected. Another implementation of module 310 adjusts the set of node weights by increasing the weight of the node at which data usage was higher than expected and lowering weights of other nodes, such as nodes near the node having an increased weight or nodes closer to the network center than the node having an increased weight. Another implementation of module 310 adjusts node weights according to a different metric.

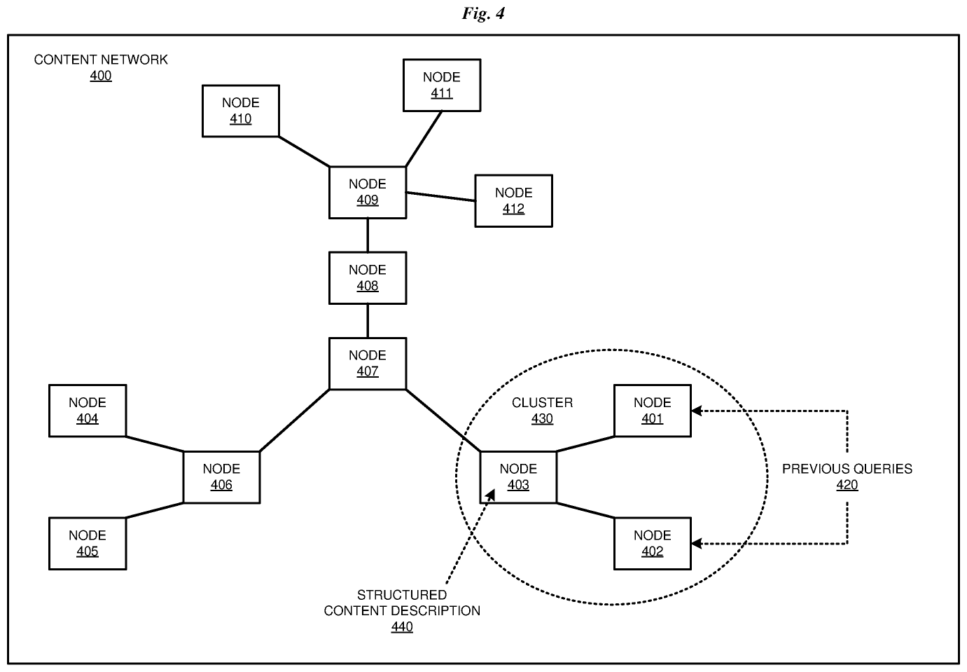

With reference to FIG. 4, this figure depicts an example of context based content positioning in content delivery networks in accordance with an illustrative embodiment. The example can be executed using application 300 in FIG. 3.

Content network 400 is a CDN including nodes 401-412. Some nodes, such as nodes 401 and 402, are located at edges of network 400. Other nodes, such as nodes 408 and 407, are located at the core of network 400, further from users but having more throughput than edge nodes. Based on the content of previous queries 420 to nodes 401 and 402, included in a content access history for network 400, application 300 has formed cluster 430, including nodes 401-403. Based on a similarity between the content access history and structured content representation 440, application 300 has positioned structured content representation 440 at node 403, ready for use in response to queries similar to queries 420.

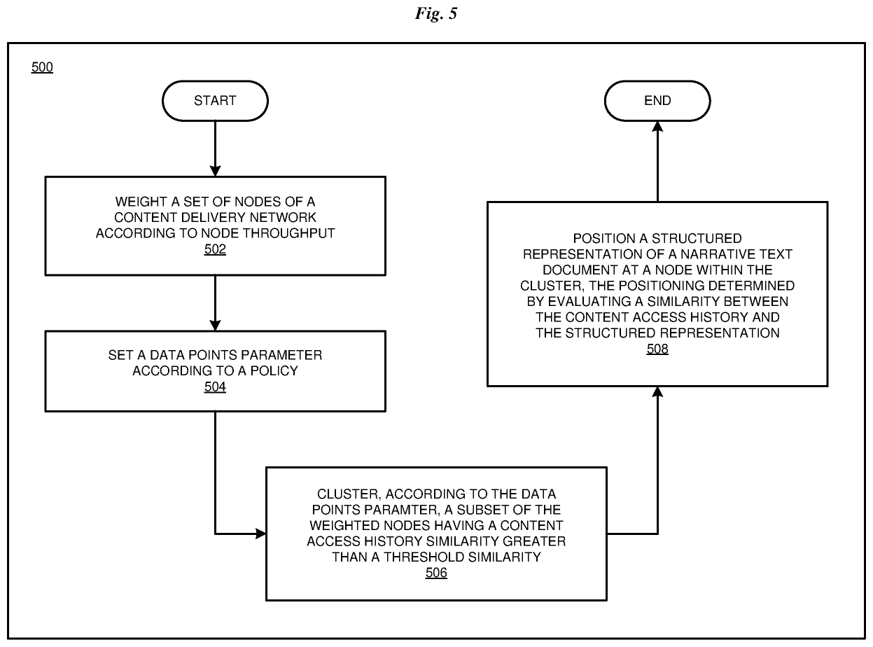

With reference to FIG. 5, this figure depicts a flowchart of an example process for context based content positioning in content delivery networks in accordance with an illustrative embodiment. Process 500 can be implemented in application 300 in FIG. 3.

In block 502, the application weights a set of nodes of a content delivery network according to node throughput. In block 504, the application sets a data points parameter according to a policy. In block 506, the application clusters, according to the data points parameter, a subset of the weighted nodes having a content access history similarity greater than a threshold similarity. In block 508, the application positions a structured representation of a narrative text document at a node within the cluster, the positioning determined by evaluating a similarity between the content access history and the structured representation. Then the application ends.

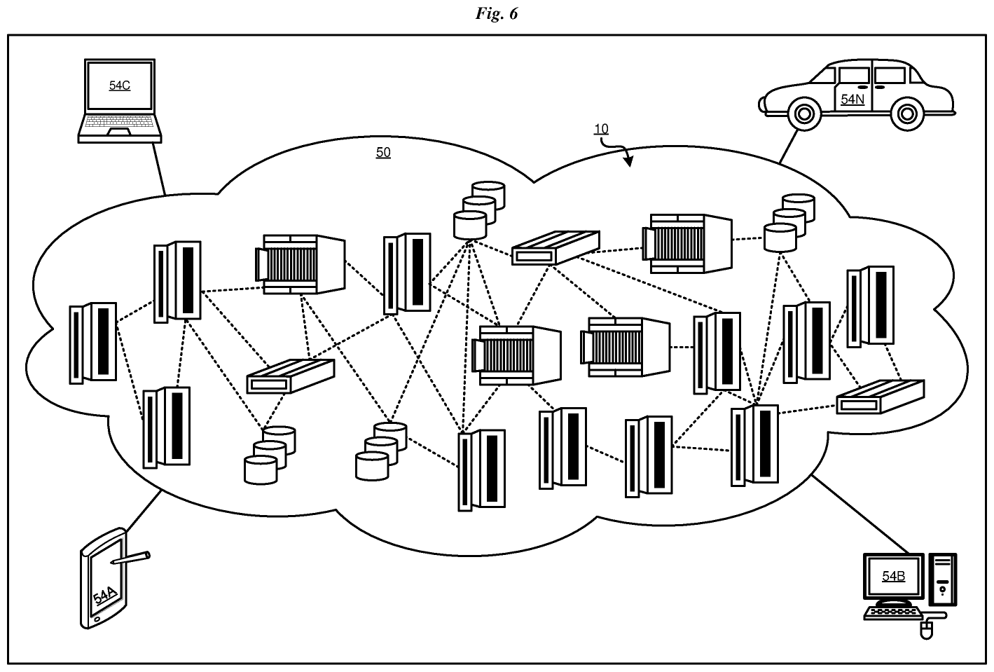

Referring now to FIG. 6, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N depicted are intended to be illustrative only and that computing nodes 10 and cloud computing environment 50 can communicate with any type of computerized device over any type of network and/or network addressable connection (e.g., using a web browser).

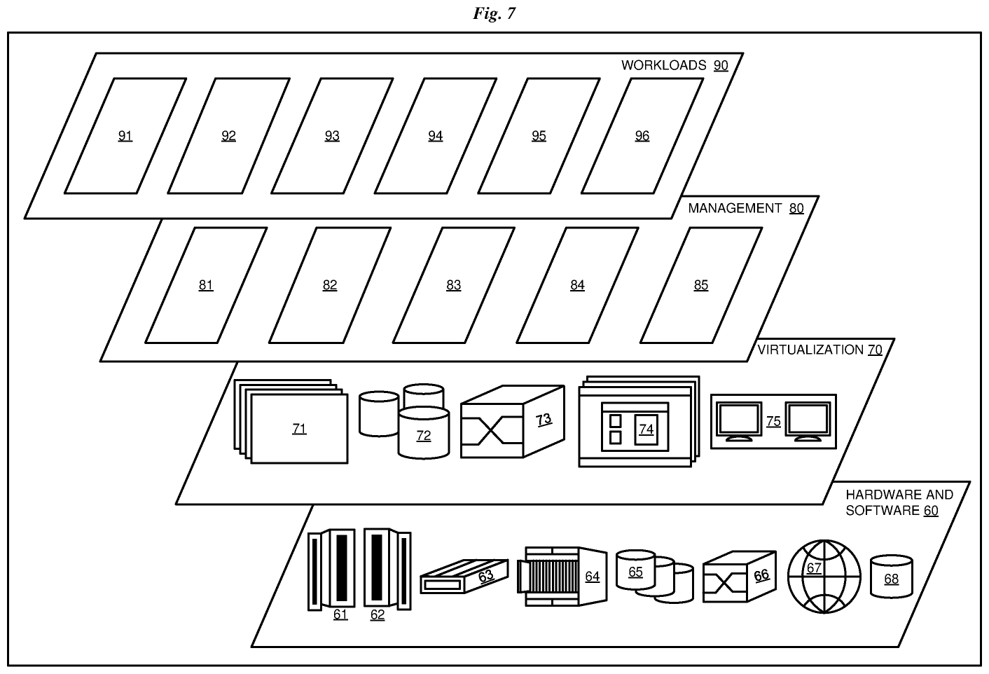

Referring now to FIG. 7, a set of functional abstraction layers provided by cloud computing environment 50 (FIG. 6) is shown. It should be understood in advance that the components, layers, and functions depicted are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and application selection based on cumulative vulnerability risk assessment 96.

Thus, a computer implemented method, system or apparatus, and computer program product are provided in the illustrative embodiments for context based content positioning in content delivery networks and other related features, functions, or operations. Where an embodiment or a portion thereof is described with respect to a type of device, the computer implemented method, system or apparatus, the computer program product, or a portion thereof, are adapted or configured for use with a suitable and comparable manifestation of that type of device.

Where an embodiment is described as implemented in an application, the delivery of the application in a Software as a Service (SaaS) model is contemplated within the scope of the illustrative embodiments. In a SaaS model, the capability of the application implementing an embodiment is provided to a user by executing the application in a cloud infrastructure. The user can access the application using a variety of client devices through a thin client interface such as a web browser (e.g., web-based e-mail), or other light-weight client-applications. The user does not manage or control the underlying cloud infrastructure including the network, servers, operating systems, or the storage of the cloud infrastructure. In some cases, the user may not even manage or control the capabilities of the SaaS application. In some other cases, the SaaS implementation of the application may permit a possible exception of limited user-specific application configuration settings.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

1. A computer-implemented method comprising:
assigning a weight to each of a set of nodes of a content delivery network, the assigning resulting in a set of weighted nodes, a weight of a weighted node in the set of weighted nodes proportional to an effect of the weighted node on a response time of the content delivery network;
setting, according to a policy, a data points parameter, the data points parameter specifying a number of weighted nodes to be grouped into a cluster, the policy specifying a network characteristic used to determine the data points parameter;
grouping, into a cluster according to a content access history of each of the weighted nodes, a subset of the weighted nodes, a number of weighted nodes in the cluster specified by the data points parameter, the cluster comprising a plurality of weighted nodes having a content access history similarity to each other greater than a threshold similarity;
selecting a weighted node within the cluster, the selecting performed by evaluating a similarity between a structured representation of a portion of content delivered by the content delivery network and a content access history of content stored within data storage of weighted nodes within the cluster, the structured representation of the portion comprising data describing the portion;
storing, within data storage of the selected weighted a node within the cluster, the structured representation of the portion;
increasing, responsive to determining that a data usage rate of the portion of content is below a threshold data usage rate, the data points parameter;
regrouping, into a second cluster according to the increased data points parameter, a second subset of the weighted nodes, the second cluster comprising nodes having a content access history similarity to each other greater than the threshold similarity, the second cluster including the selected weighted node; and
moving, from the data storage of the selected weighted node to a data storage of a second weighted node within the second cluster, the structured representation of the portion.

2. (canceled)

3. The computer-implemented method of claim 1, further comprising:
reweighting, responsive to determining that an actual data usage rate at a weighted node is above a threshold difference from an expected data usage rate at the second weighted node, the second weighted node;
regrouping, into a third cluster according to the data points parameter, a third subset of weighted nodes including the reweighted node, the third cluster comprising nodes having a content access history similarity to each other greater than the threshold similarity; and
moving, from the data storage of the reweighted second weighted node to a data storage of a weighted node within the third cluster, the structured representation of the portion.

4. The computer-implemented method of claim 1, wherein the effect comprises a throughput of the weighted node.

5. The computer-implemented method of claim 1, wherein the effect comprises a data request capacity of the weighted node.

6. The computer-implemented method of claim 1, wherein the storing is performed once the content access history includes above a threshold number of accesses to the structured representation.

7. A computer program product for content positioning in a content delivery network, the computer program product comprising:
one or more computer readable storage media, and program instructions collectively stored on the one or more computer readable storage media, the stored program instructions when executed by a processor causing operations comprising:
assigning a weight to each of a set of nodes of a content delivery network, the assigning resulting in a set of weighted nodes, a weight of a weighted node in the set of weighted nodes proportional to an effect of the weighted node on a response time of the content delivery network;
setting, according to a policy, a data points parameter, the data points parameter specifying a number of weighted nodes to be grouped into a cluster, the policy specifying a network characteristic used to determine the data points parameter;
grouping, into a cluster according to a content access history of each of the weighted nodes, a subset of the weighted nodes, a number of weighted nodes in the cluster specified by the data points parameter, the cluster comprising a plurality of weighted nodes having a content access history similarity to each other greater than a threshold similarity;
selecting a weighted node within the cluster, the selecting performed by evaluating a similarity between a structured representation of a portion of content delivered by the content delivery network and a content access history of content stored within data storage of weighted nodes within the cluster, the structured representation of the portion comprising data describing the portion;
storing, within data storage of the selected weighted a node within the cluster, the structured representation of the portion;
increasing, responsive to determining that a data usage rate of the structured representation is below a threshold data usage rate, the data points parameter;
regrouping, into a second cluster according to the increased data points parameter, a second subset of the weighted nodes, the second cluster comprising nodes having a content access history similarity to each other greater than the threshold similarity, the second cluster including the selected weighted node; and
moving, from the data storage of the selected weighted node to a data storage of a second weighted node within the second cluster, the structured representation of the portion.

8. (canceled)

9. The computer program product of claim 7, the stored program instructions further comprising:
reweighting, responsive to determining that an actual data usage rate at a weighted node is above a threshold difference from an expected data usage rate at the second weighted node, the second weighted node;
regrouping, into a third cluster according to the data points parameter, a third subset of weighted nodes including the reweighted node, the third cluster comprising nodes having a content access history similarity to each other greater than the threshold similarity; and
moving, from the data storage of the reweighted second weighted node to a data storage of a weighted node within the third cluster, the structured representation of the portion.

10. The computer program product of claim 7, wherein the effect comprises a throughput of the weighted node.

11. The computer program product of claim 7, wherein the effect comprises a data request capacity of the weighted node.

12. The computer program product of claim 7, wherein the stored program instructions are stored in the at least one of the one or more storage media of a local data processing system, and wherein the stored program instructions are transferred over a network from a remote data processing system.

13. The computer program product of claim 7, wherein the stored program instructions are stored in the at least one of the one or more storage media of a server data processing system, and wherein the stored program instructions are downloaded over a network to a remote data processing system for use in a computer readable storage device associated with the remote data processing system.

14. The computer program product of claim 7, wherein the computer program product is provided as a service in a cloud environment.

15. A computer system comprising one or more processors, one or more computer-readable memories, and one or more computer-readable storage media, and program instructions stored on at least one of the one or more storage media for execution by at least one of the one or more processors via at least one of the one or more memories, the stored program instructions when executed by a processor causing operations comprising:
assigning a weight to each of a set of nodes of a content delivery network, the assigning resulting in a set of weighted nodes, a weight of a weighted node in the set of weighted nodes proportional to an effect of the weighted node on a response time of the content delivery network;
setting, according to a policy, a data points parameter, the data points parameter specifying a number of weighted nodes to be grouped into a cluster, the policy specifying a network characteristic used to determine the data points parameter;
grouping, into a cluster according to a content access history of each of the weighted nodes, a subset of the weighted nodes, a number of weighted nodes in the cluster specified by the data points parameter, the cluster comprising a plurality of weighted nodes having a content access history similarity to each other greater than a threshold similarity;
selecting a weighted node within the cluster, the selecting performed by evaluating a similarity between a structured representation of a portion of content delivered by the content delivery network and a content access history of content stored within data storage of weighted nodes within the cluster, the structured representation of the portion comprising data describing the portion;
storing, within data storage of the selected weighted a node within the cluster, the structured representation of the portion;
increasing, responsive to determining that a data usage rate of the structured representation is below a threshold data usage rate, the data points parameter;
regrouping, into a second cluster according to the increased data points parameter, a second subset of the weighted nodes, the second cluster comprising nodes having a content access history similarity to each other greater than the threshold similarity, the second cluster including the selected weighted node; and
moving, from the data storage of the selected weighted node to a data storage of a second weighted node within the second cluster, the structured representation of the portion.

16. (canceled)

17. The computer system of claim 15, the stored program instructions further comprising:
reweighting, responsive to determining that an actual data usage rate at a weighted node is above a threshold difference from an expected data usage rate at the second weighted node, the second weighted node;
regrouping, into a third cluster according to the data points parameter, a third subset of weighted nodes including the reweighted node, the third cluster comprising nodes having a content access history similarity to each other greater than the threshold similarity; and
moving, from the data storage of the reweighted second weighted node to a data storage of a weighted node within the third cluster, the structured representation of the portion.

18. The computer system of claim 15, wherein the effect comprises a throughput of the weighted node.

19. The computer system of claim 15, wherein the effect comprises a data request capacity of the weighted node.

20. The computer system of claim 15, wherein the stored program instructions are stored in the at least one of the one or more storage media of a local data processing system, and wherein the stored program instructions are transferred over a network from a remote data processing system.
